(19) United States
(12) Patent Application Publication
(10) Pub. No.: US 2007/0140825 A1
(43) Pub. Date: Jun. 21, 2007

(54) Method and device for the intermediate storage of stacks

(75) Inventor: Manfred Ruegsegger, Schenkon LU (CH)

Correspondence Address: VENABLE LLP, P.O. BOX 34385, WASHINGTON, DC, 20043-9998, US

(73) Assignee: Muller Martini holding AG, Hergiswil (CH)

(21) Appl. No.: 11/602,998

(22) Filed: Nov. 22, 2006

(30) Foreign Application Priority Data
Nov. 23, 2005 (EP) 05405655.1

(51) Int. Cl. B65G 57/03; B65H 29/56

(52) U.S. Cl. 414/794.3

(57) ABSTRACT

A method for intermediate storage of stacks involves successively lining up print products and forming these into a stack. The stacks are formed by successively lining up the print products with the aid of a sheet delivery. The formed stacks are then transferred with the aid of transporting mechanism to an intermediate storage area. At least two separate, comparatively short stacks are combined to form a compound stack and are then transferred jointly and with the aid of the aforementioned transporting mechanism to the intermediate storage area, wherein standard pallets can be used for the intermediate storage.

### CROSS-REFERENCE TO RELATED APPLICATION

This application claims the priority of European Patent Application No. 05405655.1, filed on Nov. 23, 2005, the disclosure of which is incorporated herein by reference in its entirety.

### BACKGROUND

The present invention relates to a method for intermediate storage of stacks or bundles, formed with successively lined-up products, involving a stack or bundle-forming device in the form of a sheet delivery on which the stacks are formed by successively lining up the print products, an intermediate storage area for the intermediate storage of the formed stacks, and transporting means for transferring the formed stacks to the intermediate storage area. The invention furthermore relates to a device for the intermediate storage of stacks.

European patent document EP 0 623 542 A, incorporated herein by reference, discloses a device by means of which the aforementioned stacks can be formed and conveyed to an intermediate storage area. The stacks are composed of printed sheets which are supplied in an overlapping flow to the device. A press is used to compress the upright-positioned printed sheets into a compact stack, wherein the stacks are simultaneously also strapped with a band and the finished stacks are then palletized for the intermediate storage.

European patent document EP 1 378 472 A, incorporated herein by reference, discloses a different type of device for the forming and intermediate storage of such stacks. A horizontally and vertically traversing clamp is arranged above a stack support and serves to press together the stack ends. The clamp is furthermore used to transfer the strapped stacks from the stack support to an adjacent intermediate storage area. Stacks formed in this way have lengths, for example, of 1,000 or 1,200 mm. These stacks (also called bundles) are extremely heavy and cannot be fed manually during the further processing. Short stacks having a length 500 or 600 mm are therefore also produced, which can be fed manually, for example to a gathering and wire-stitching machine, during the further processing. For the intermediate storage, these stacks are stored on half pallets, which are then used in the same way as standard Euro pallets. The disadvantage of this device is that it requires more pallets than in the past for the intermediate storage. In principle, the short stacks could also be stored on standard Euro pallets for the intermediate storage, but an optimum use of these pallets would not be possible with short stacks.

### SUMMARY

It is therefore an object of the present invention to provide a method and a device of the aforementioned type, which permit an easier and more cost-effective intermediate storage.

The above and other objects are accomplished for a generic method of the type first described above by combining respectively at least two comparatively short stacks into a compound stack and to convey the compound stack with the aid of the aforementioned transporting mechanism to the intermediate storage area. The compound stacks can be stacked on a Euro pallet, in the same way as the presently used long stacks, thereby permitting an optimum use of the pallets. This type of intermediate storage is space-saving because no gaps or intermediate spaces are formed on the pallet. In addition, the loaded pallets are extremely stable during the transport. Standard long stacks and compound stacks can therefore be stacked optimally and simultaneously on a single pallet. The stacks can be moved manually for the further processing because the short stacks weigh considerably less than the long stacks used so far. Shorter cycle times/stacks are also possible because several short stacks together can be palletized considerably faster than individual long stacks. The comparatively short stacks preferably are noticeably shorter than 1,000 mm, wherein the compound stacks can be stacked either parallel or crosswise.

According to a different embodiment, at least two strapped stacks are moved onto a table, in particular a roller table, and are combined thereon to form a compound stack. The stacks are advantageously combined along an end stop of the table.

In a further embodiment, the stacks are fitted together end-to-end, wherein a compound stack composed of two individual stacks consequently has a length that is the sum of the lengths of the two short stacks. In principle, more than two stacks can also be combined in this way. According to an other embodiments, the stacks are combined by placing one above the other or side-by-side to form a compound stack.

### BRIEF DESCRIPTION OF THE DRAWINGS

These and other features and advantages of the invention will be further understood from the following detailed description with reference to the accompanying drawings.

FIG. 1 is a schematic view from above of a device according to the invention.

FIG. 2 is a schematic view from the side of a section of the device according to the invention.

FIG. 3 is a schematic three-dimensional view of a table for combining two stacks to form a compound stack.

FIG. 4 is a schematic three-dimensional view of a double-length stack.

FIG. 5 is a schematic view of a compound stack according to a modified version.

### DETAILED DESCRIPTION

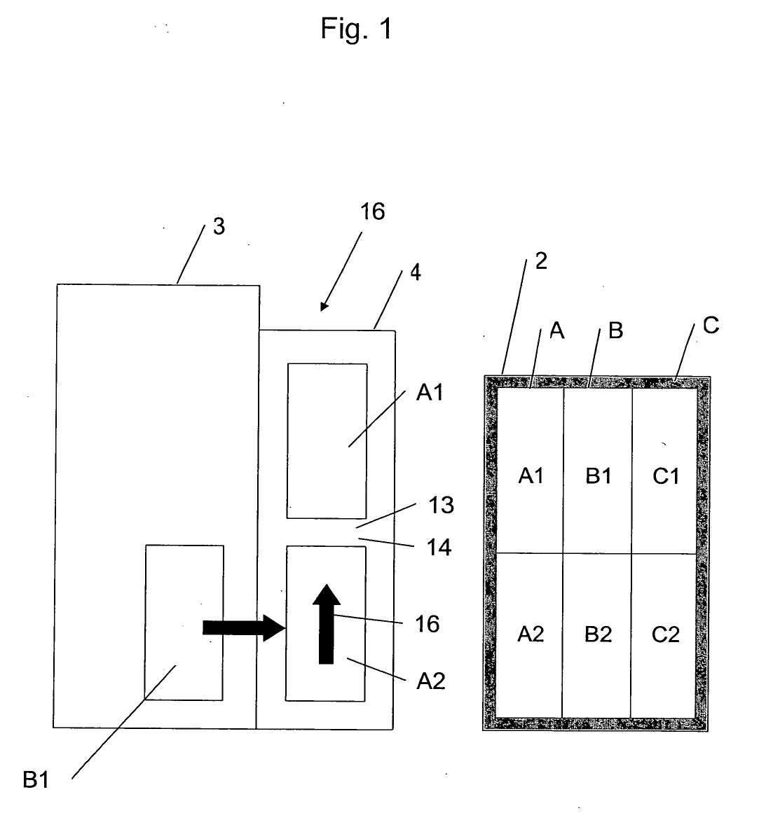

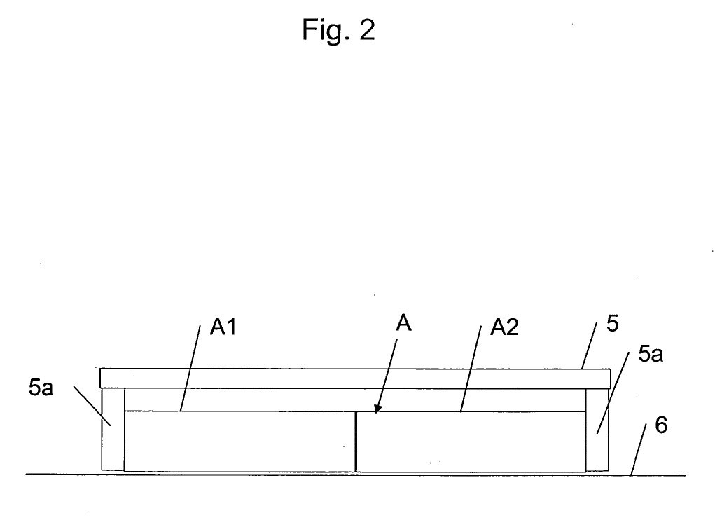

The device 1 shown in FIGS. 1 and 2 is provided with a sheet delivery 3, which is known per se and can be embodied as described in the above mentioned European patent document EP 1 378 472 A. The device 1 furthermore comprises a table 4, for example embodied as a roller table, which can accommodate at least two stacks A1 and A2. The table 4 is provided with an end stop 8 for positioning the stacks. A pallet 2, for example a standard Euro pallet, is located adjacent to the table 4. A stack support 6 is located in front of the table 4, to which the print products 12 to be stacked are supplied in an overlapping flow.

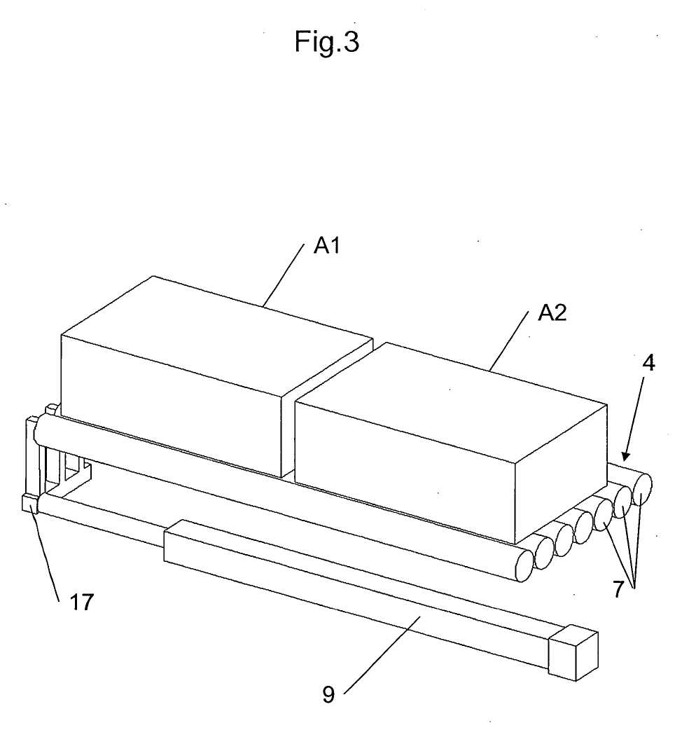

FIG. 3 shows a diagram of the table 4, which is provided with a plurality of rollers 7 that are arranged so that the stacks A1 and A2 can be displaced transverse to their longitudinal direction, without substantial expenditure of force. According to FIG. 3, a pusher 17 is provided for displacing the stacks, wherein the pusher moves in a longitudinal direction of rollers 7 with the aid of a hydraulic or pneumatic cylinder 9. However, the use of other displacement mechanisms is also conceivable.

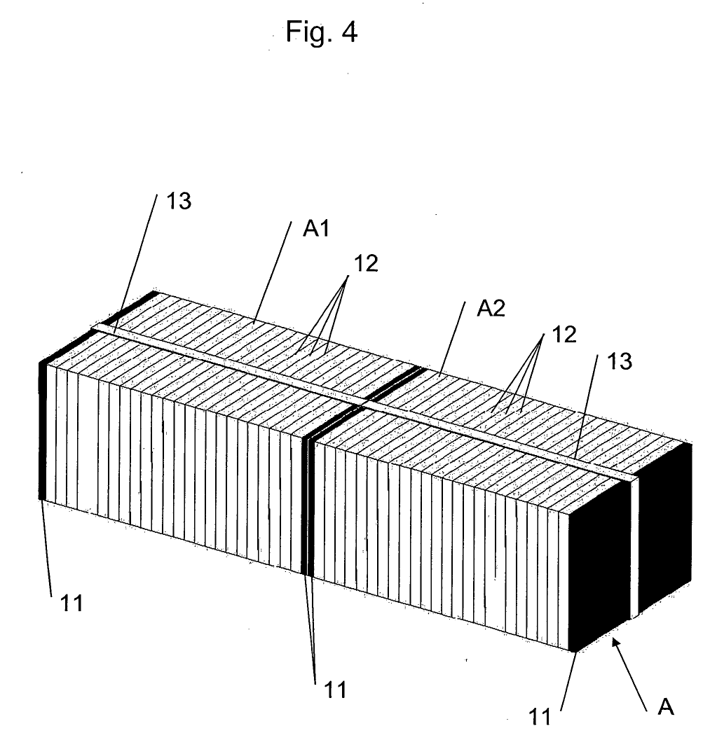

The stacks A1 and A2 are comparatively short stacks, measuring approximately 500 mm or 600 mm. The stacks A1 and A2 accordingly are lightweight and can be moved by hand, wherein other lengths are conceivable as well. The lengths of stacks A1 and A2 must be such that they can be lifted up manually. According to FIG. 4, the stacks A1 and A2 are each strapped with a strap 13 and are provided at the ends with respectively one end plate 11, in a manner known per se, wherein these end plates 11 are made from wood. The print products 12 are respectively positioned so as to stand upright between these end plates 11. The print products 12 are positioned upright and respectively parallel to the end plates 11.

The two stacks A1 and A2 are arranged spaced apart on the table 4, as shown in FIG. 1, so that the fronts 13 and 14 are at a distance to each other. These two stacks A1 and A2 are then joined in the direction of arrow 16, such that the fronts 13 and 14 fit against each other. The end stop 8 functions to position the newly formed double stack when the individual stacks are pushed together. The clamp 5, shown in FIG. 2, then grips the compound stack, wherein the jaws 5a fit against the ends of the formed compound stack A and the clamp presses the individual stacks A1 and A2 together, so that they can be transported jointly. The clamp 5 of a device that is not shown herein is embodied so that it can lift up the compound stack A and can subsequently transfer it to the pallet 2 for the intermediate storage.

Once the compound stack A is deposited on the pallet, the clamp 5 opens up and is then ready for transporting a second compound stack B and/or C. While the stacks A1 and A2 are in the process of being combined, a different stack B1 can already be formed in the sheet delivery 3 as shown in FIG. 1. As soon as the table 4 is cleared, the stack B1 can then be moved onto the table 4. However, if a second stack B2 is already positioned next to the stack B1 on the table 4, these two stacks can be combined to form a compound stack B, as explained in the above, which can then be transferred to the pallet 2. The compound stack C is formed in the same way and is then deposited on the pallet 2. The compound stacks A, B and C can be arranged parallel on the pallet 2, as shown in FIG. 1, or also crosswise. For the crosswise stacking, the pallet 2 can be arranged on a rotary table that is not shown herein. The same is true for the additional compound stacks, which are deposited as second or third layers on the stack 2. As can be seen, the compound stacks A, B and C are deposited without intermediate spaces on the pallet 2, such that they are stacked in an extremely compact manner on the pallet 2. Since the stacks A1 to C2 are small and/or comparably lightweight stacks and are not actually joined, they can be removed manually and individually from the pallet 2 and can be supplied, for example, to a feeder of a gathering and wire-stitching machine. Of course, a machine removal is possible as well.

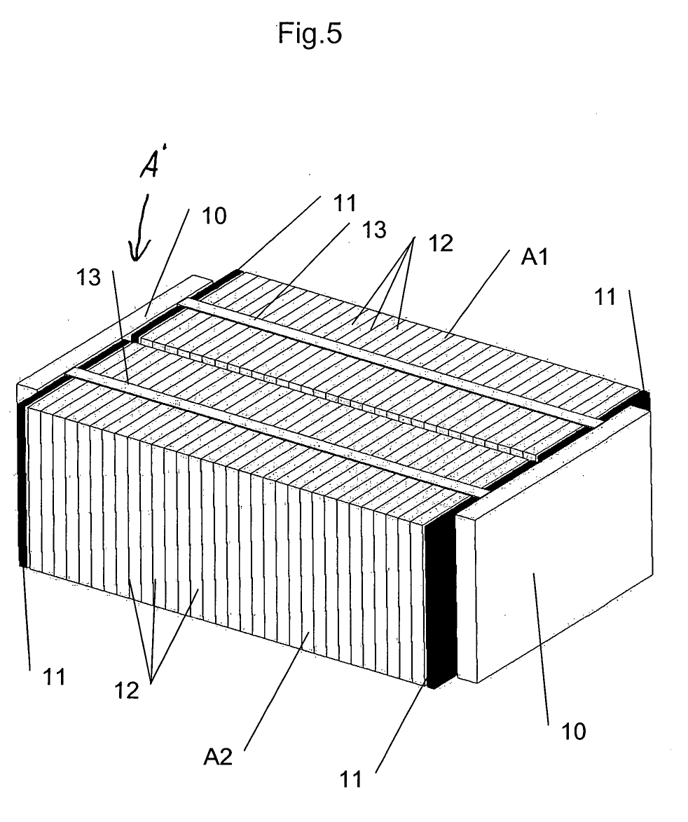

FIG. 5 shows a compound stack A′ where the individual stacks A1 and A2 are not joined at the ends, but along the sides. The two stacks A1 and A2 can be arranged side-by-side in a horizontal plane as well as one above the other. For the transport from the table 4 to the pallet 2, this compound stack A′ is also gripped by a clamp 10, provided with correspondingly wider jaws than the clamp 5 shown in FIG. 2. For this embodiment, it is also possible to combined more than two stacks, for example three or four stacks, to form a triple and/or quadruple compound stack.

The device 1 for realizing this method is consequently provided with means 5 for combining the stacks A1 and A2 and/or B1 and B2 and/or Cl and C2 to form a compound stack A, B and/or C. The device is further provided with means 5 and/or 10 for transporting these compound stacks to the pallet 2 or to a different suitable intermediate storage area, wherein the intermediate storage area does not have to be a pallet 2.

It will be understood that the above description of the present invention is susceptible to various modifications, changes and adaptations, and the same are intended to be comprehended within the meaning and range of equivalents of the appended claims.

What is claimed is:

1. A method for intermediate storage of stacks composed of successively lined up print products forming a stack, the method comprising:
successively lining up the print products to form stacks on a sheet feeder; and
combining at least two stacks to form a compound stack and transporting the compound stack to the intermediate storage area.

2. The method according to claim 1, wherein the combining step includes separately moving at least two stacks onto a table and combining the at least two stacks on the table to form the compound stack.

3. The method according to claim 2, further including positioning the stacks to be ready for removal.

4. The method according to claim 2, including joining the stacks along their respective end faces.

5. The method according to claim 2, including positioning the stacks side-by-side or one above the other.

6. A device implementing the method according to claim 1, comprising:
a sheet delivery to form the stacks;
a table on which two or more stacks can be combined to form the compound stack; and
a transporter to place respectively one compound stack into a removal position, such that the compound stack can be gripped and transferred to the intermediate storage area.

7. The device according to claim 6, wherein the sheet delivery includes a stack support on which the stacks are formed.

8. The device according to claim 6, wherein the table comprises a roller table.

9. The device according to claim 6, further including means for strapping the stacks.

10. The device according to claim 6, wherein the intermediate storage area is a pallet.
